(19) United States
(12) Patent Application Publication
(10) Pub. No.: US 2019/0227927 A1
(43) Pub. Date: Jul. 25, 2019

(54) DATA STORAGE DEVICE AND DATA STORAGE METHOD FOR DYNAMICALLY EXECUTING A GARBAGE-COLLECTION PROCESS

(71) Applicant: Shannon Systems Ltd., Shanghai (CN)

(72) Inventor: Ningzhong MIAO, Shanghai (CN)

(21) Appl. No.: 16/239,714

(22) Filed: Jan. 4, 2019

(30) Foreign Application Priority Data
Jan. 19, 2018 (CN) 201810054111.9

(51) Int. Cl. G06F 12/02; G06F 3/06

(52) U.S. Cl. CPC G06F 12/0253; G06F 12/0246; G06F 3/0679; G06F 3/0658; G06F 3/0608

(57) ABSTRACT

A data storage device utilized for dynamically executing a garbage-collection process is provided. The data storage device includes a flash memory and a controller. The flash memory includes a plurality of blocks. Each of the blocks includes a plurality of pages. The controller is coupled to the flash memory and is configured to calculate whether or not the number of spare blocks is lower than a predetermined value, and to execute the garbage-collection process according to the difference value between the predetermined value and the number of spare blocks. The garbage-collection process merges at least two data blocks to release at least one spare block.

### CROSS REFERENCE TO RELATED APPLICATIONS

This Application claims priority of China Patent Application No. 201810054111.9 filed on Jan. 19, 2018, the entirety of which is incorporated by reference herein.

### BACKGROUND OF THE INVENTION

### Field of the Invention

The present invention relates to a data storage device including a FLASH memory, and in particular it relates to executing the garbage-collection process on the FLASH memory.

### Description of the Related Art

Garbage-collection (GC) processes are widely used on various kinds of memory devices. Specifically, a garbage-collection process merges inefficient blocks where most of the pages are invalid into one efficient block, thereby obtaining more spare blocks (which are called data blocks). Accordingly, several data block storing invalid data can be recycled into spare blocks. Therefore, by regularly executing a garbage-collection process, the efficiency of the storage device can be improved.

However, whether the garbage-collection process is triggered is usually determined by a single threshold value. When it is determined that the garbage-collection process is to be executed, the performance of the storage device drops. Furthermore, a large amount of data can be written into the data storage device within a short amount of time, and consuming many blocks. When the data is written and the garbage-collection process is executed simultaneously, write latency may suddenly increase, and performance may drop abruptly due to the execution of the garbage-collection process. Therefore, a dynamically adjusted garbage-collection process is needed to prevent the memory device from experiencing an abrupt drop in performance, and also accord with various kinds of operation status and host commands.

### BRIEF SUMMARY OF THE INVENTION

The bandwidth and speed of the garbage-collection process are adjusted dynamically based on the comparison of the predetermined value and the number of spare blocks by the present invention. When the host writes more data, the number of spare blocks decreases. Calculating the number of spare blocks could reflect the situation of wiring data by the host. However, the present invention does not initiate the garbage-collection process immediately when the host writes data, and it does not allow the garbage-collection process to occupy the access speed of the flash memory. The bandwidth and speed of the garbage-collection process will be adjusted dynamically after a period of time. Therefore, writing latency may be prevented and the number of spare blocks can be maintained by the data storage method of the present invention so that the data storage device can operate properly and smoothly.

In one aspect of the invention, a data storage device utilized for dynamically executing a garbage-collection process is provided. The data storage device includes a flash memory and a controller. The flash memory includes a plurality of blocks. Each of the blocks comprises a plurality of pages. The controller is coupled to the flash memory and configured to calculate whether or not the number of spare blocks is lower than a predetermined value, and to execute the garbage-collection process according to the difference value between the predetermined value and the number of spare blocks. The garbage-collection process merges at least two data blocks to release at least one spare block.

When the number of spare blocks in the flash memory is lower than the predetermined value, the controller sets up a threshold bandwidth based on the number of spare blocks. When the difference value between the predetermined value and the number of spare blocks is greater, or there are fewer spare blocks, the threshold bandwidth is greater. In one embodiment, the controller determines whether or not the writing data bandwidth is less than the threshold bandwidth, and the writing data bandwidth is the speed at which the host writes data into the data storage device. When the writing data bandwidth is less than the threshold bandwidth, the controller calculates the difference value between the threshold bandwidth and the writing data bandwidth and executes the garbage-collection process based on the difference value. When the writing data bandwidth is greater than the threshold bandwidth, the controller does not initiate the garbage-collection process. When the writing data bandwidth is smaller than the threshold bandwidth, the controller initiates the garbage-collection process.

Furthermore, when the writing data bandwidth is smaller or the threshold bandwidth is greater, the bandwidth of the garbage-collection process executed by the controller is greater. The controller periodically calculates the number of spare blocks in the flash memory, and it determines whether or not the number of spare blocks is lower than the predetermined value.

In another aspect of the invention, a data storage method for dynamically executing a garbage-collection process is provided. The data storage method is applied to a data storage device which comprises a flash memory and a controller. The flash memory includes a plurality of blocks. Each of the blocks includes a plurality of pages. The data storage method includes: calculating the number of spare blocks in the flash memory; determining whether or not the number of spare blocks is lower than a predetermined value; and executing the garbage-collection process according to the difference value between the predetermined value and the number of spare blocks, wherein the garbage-collection process merges at least two data blocks to release at least one spare block.

Other aspects and features of the present invention will become apparent to those with ordinarily skill in the art upon review of the following descriptions of specific embodiments of the data storage device and the data storage method.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram illustrating the data storage device according to an embodiment of the invention;

FIG. 2 is a schematic illustrating the execution of the garbage-collection process based on the number of spare blocks according to an embodiment of the invention;

FIG. 3 is a schematic illustrating the relation between the threshold bandwidth, the writing data bandwidth and the bandwidth of the garbage-collection process according to an embodiment of the invention;

FIG. 4 is a schematic illustrating the writing data bandwidth and the bandwidth of the garbage-collection process according to an embodiment of the invention;

FIG. 5 is a schematic illustrating a data storage method for executing the garbage-collection process according to an embodiment of the invention;

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE INVENTION

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

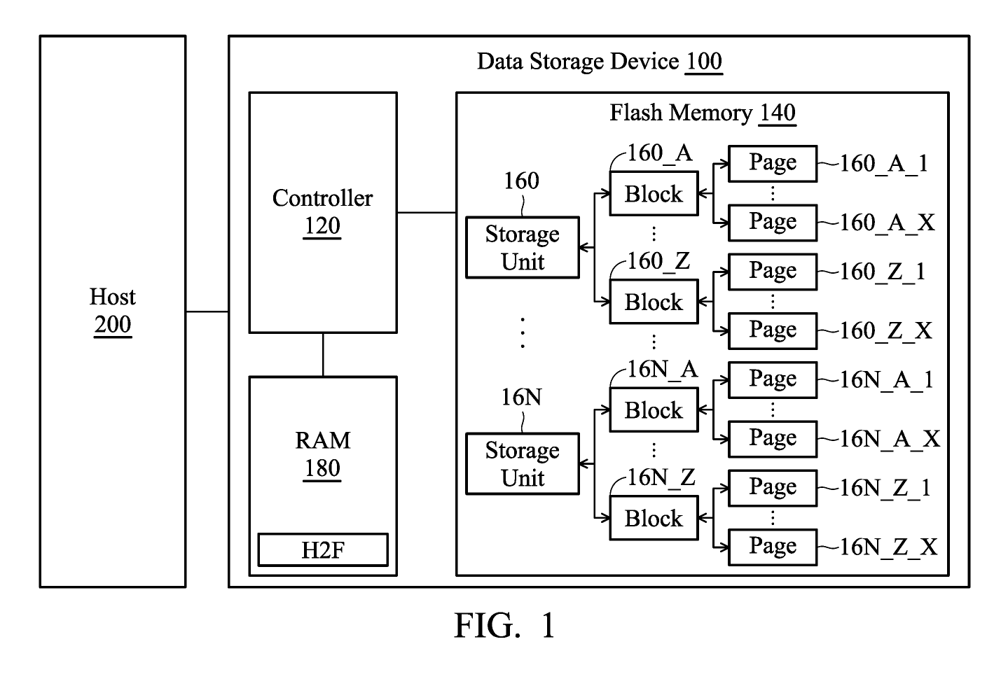

FIG. 1 is a schematic illustrating the data storage device 100 and the host 200 according to an embodiment of the invention. In one embodiment, the data storage device 100 includes a controller 120, a non-volatile memory and a random access memory (RAM) 180. The data storage device 100 is coupled to the host for transmitting or receiving data and commands. The communication protocol between the data storage device 100 and the host 200 complies with the eMMC standard, UFS standard, SD standard, SATA standard, or NVMe standard. The non-volatile memory may be NAND flash, magneto-resistive RAM, ferroelectric RAM, resistive RAM (RRAM), spin transfer torque RAM (STT-RAM), and so on, which is able to store data for a long time. The flash memory 140 will be used as an example for illustration in the following description, but it is not limited thereto.

As shown in FIG. 1, the controller 120 is coupled to the flash memory 140 and the RAM 180. The RAM 180 is utilized to temporarily store and cache the data which is requested by the controller 120, or temporarily store data which will be written to the flash memory 140 by the host 200 later on in order to shorten access time on the data storage device 100. The RAM 180 is preferably SRAM, or it may be DRAM.

The controller 120 is coupled to the flash memory 140 to transmit data and instructions or to receive data and instructions mutually. In one embodiment, there are four channels (CH0˜CH3) between the controller 120 and the flash memory 140 to transmit data or commands. Furthermore, the controller 120 can be a read-only-memory (ROM) and a micro-controller with firmware code, and the micro-controller executes the firmware code to operate or access the flash memory 140.

The flash memory 140 includes a storage matrix which is composed of a plurality of storage units 160˜16N. In one embodiment, each storage unit includes at least one die, and each die includes at least one plane. Each plane includes several blocks 160_A˜16N_Z, and each block includes several pages. In one embodiment, each block of each plane is grouped as a super block so that the flash memory 140 can include several super blocks and each super block includes several super pages. Because a page and a super page have similar operation features, they will be illustrated alternatively in the following specification for simplicity, but are not limited.

As shown in FIG. 1, the storage unit 160 includes several blocks 160_A˜160_Z. The storage unit 16N includes several blocks 16N_A˜16N_Z. For example, Z is 2048. Regarding the storage unit 160, each of the blocks 160_A˜160_Z further includes several pages 160_A_1˜16N_Z_X. For example, X is 768, the data storage capacity of each page 160_A_1˜16N_Z_X is 16 KB, and the page capacity of a page is four times the data unit of 4 KB. When the writing operation is performed on the flash memory 140 by the controller 120, the data is written into a page since a page is the minimum data writing unit. A page is controlled by a word line.

Regarding the flash memory 140, each page 160_A_1˜16N_Z_X of the blocks 160_A˜16N_Z has a different physical address. When a data writing operation is performed by the data storage device 100, the controller 120 determines the physical address of the flash memory 140 in which to write data. In addition, the controller 120 maps the above physical addresses to the respective logical addresses of data, and maintains a mapping table H2F. Therefore, regarding the host 200, the host 200 requests to read data from the data storage device 100 through the logical address. The controller 120 obtains the physical address by utilizing the mapping table H2F and the logical address, and provides the data stored on the physical address to the host 200. The mapping table H2F can be created and maintained by the controller 120, or it can be created and maintained by the host 200.

In one embodiment, the controller 120 is utilized to execute a garbage-collection process on the FLASH memory 140 according to numbers of spare blocks in the FLASH memory 140. The garbage-collection process is utilized for merging the data (valid) of at least two data blocks and releasing at least one spare block from the data blocks. For further illustration, the spare block is characterized by each of its pages being empty and without any written data. The data block is characterized by a portion or all of its pages being stored with data. If most of the pages of a data block are invalid or without any written data, the data block is an inefficient block. Specifically, an inefficient block is a data block which will be recycled in the garbage-collection process.

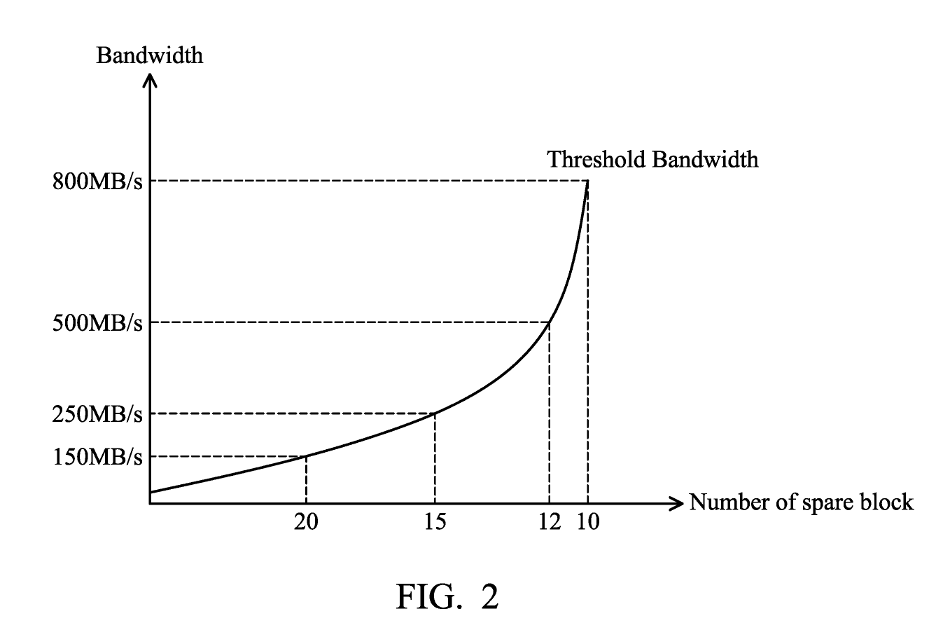

In one embodiment, the garbage-collection process is adjusted dynamically according to the number of spare blocks, rather than being executed or operated based on a single threshold value, thereby avoiding obviously operating latency on the flash memory 140. The controller 120 calculates whether or not the number of spare blocks in the flash memory 140 is lower than a predetermined value. When the number of spare blocks in the flash memory 140 is lower than a predetermined value, the controller 120 dynamically adjusts the speed of the garbage-collection process according to the difference value between the number of spare blocks and the predetermined value. As shown in FIG. 2, the threshold bandwidth becomes greater when the difference value between the number of spare blocks and the predetermined value is greater or when there are fewer spare blocks. The relationship between them can be a linear relationship, an exponential relationship, or a non-linear relationship.

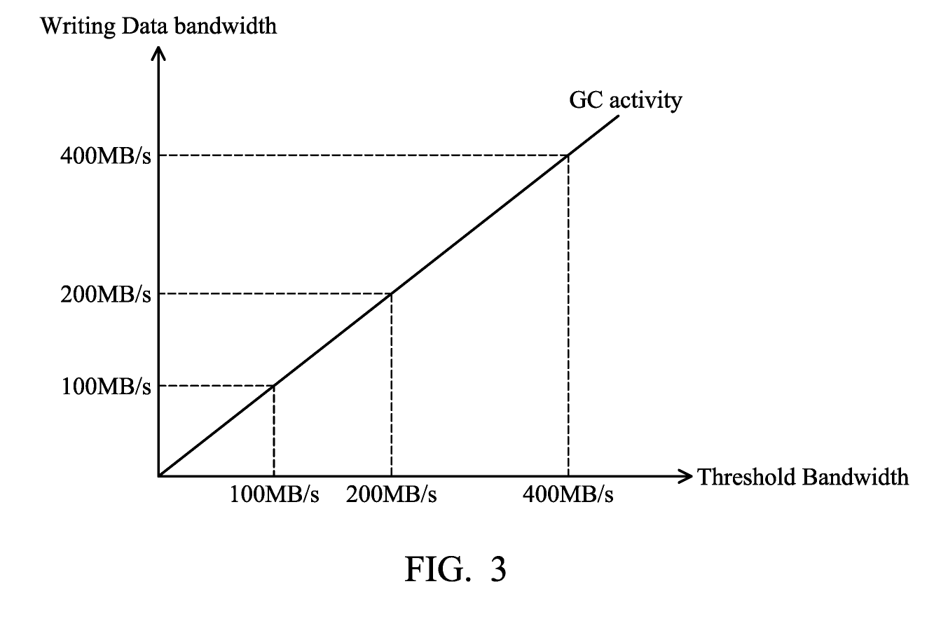

As shown in FIG. 3, the relationship between the threshold bandwidth, the writing data bandwidth and the bandwidth of the garbage-collection process may be illustrated by the following equation:

Bandwidth of the garbage-collection process=Threshold bandwidth−Writing data bandwidth

It can be seen from the above equation that when the writing data bandwidth is greater than the threshold bandwidth, the garbage-collection process will not be executed. When the writing data bandwidth is smaller than the threshold bandwidth, the garbage-collection process will be executed. The bandwidth of the garbage-collection process becomes greater when the writing data bandwidth is smaller or when the threshold bandwidth is smaller. The bandwidth is the data transmission amount per second. The writing data bandwidth is the data transmission amount of the data storage device 100 per second. The bandwidth of the garbage-collection process is the data transmission amount of the garbage-collection process per second.

In one embodiment, when the host 200 writes the data into the data storage device 100, the garbage-collection process will not be initiated by the controller 120 immediately. When the host 200 writes more data into the data storage device 100, the number of spare blocks in the flash memory 140 is reduced. When the number of spare blocks in the flash memory 140 is lower than the predetermined value, the threshold bandwidth will be determined based on the number of spare blocks and the difference value with the predetermined value.

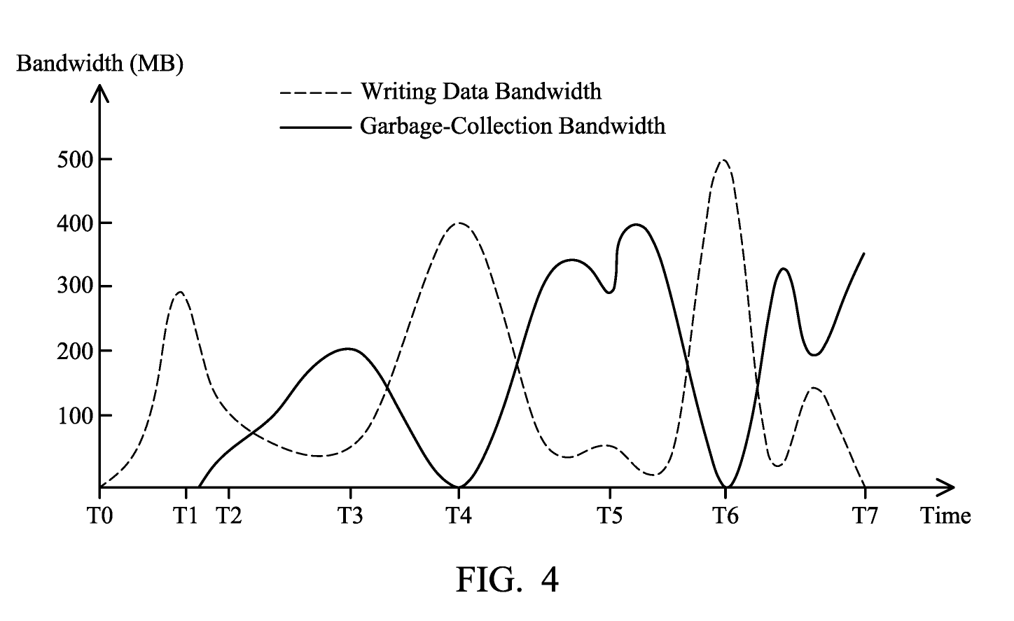

FIG. 4 is a schematic illustrating the writing data bandwidth (as shown by the dotted line) and the bandwidth of the garbage-collection process (as shown by the solid line) according to an embodiment of the invention. The host 200 starts to write data into the data storage device 100 at time T0, and it writes data into the data storage device 100 with a speed of 300 MB/sec at time T1. At time T1, the controller 120 calculates that the number of spare blocks in the flash memory 140 is not lower than the predetermined value (such as 25). In other words, the number of spare blocks is enough. Therefore, the garbage-collection process is not executed immediately by the controller 120 at time T1. In addition, the number of spare blocks in the flash memory 140 is calculated periodically by the controller 120. For example, the number of spare blocks in the flash memory 140 is calculated periodically by the controller 120 at each 1 mini-second. At time T2, the controller 120 determines that the number of spare blocks in the flash memory 140 is 20, which is lower than the predetermined value, the controller 20 starts to execute the garbage-collection process, and the controller 120 determines that the threshold bandwidth is equal to 150 MB/second based on the number of spare blocks. Because the writing data bandwidth is 100 MB/second, the bandwidth of the garbage-collection process will be 50 MB/second. Therefore, when the spare blocks are consumed, initiating the garbage-collection process can reduce the consumption of spare blocks. Accordingly, the performance of the data storage device 100 is not affected by the garbage-collection process, and not too many spare blocks are used.

At time T3, the controller 120 determines that the number of spare blocks in the flash memory 140 is 15, which is lower than the predetermined value, and it determines that the threshold bandwidth is equal to 250 MB/second based on the number of spare blocks. Because the writing data bandwidth is 50 MB/second, the bandwidth of the garbage-collection process will be 200 MB/second. Since the bandwidth of the garbage-collection process is greater than the writing data bandwidth, the number of spare blocks can be increased obviously by the garbage-collection process.

At time T4, the controller 120 determines that the number of spare blocks in the flash memory 140 is 20, which is lower than the predetermined value, and it determines that the threshold bandwidth is equal to 150 MB/second based on the number of spare blocks. Because the writing data bandwidth is 400 MB/second, the bandwidth of the garbage-collection process will be OMB/second.

At time T5, the controller 120 determines that the number of spare blocks in the flash memory 140 is 13, which is lower than the predetermined value, and it determines that the threshold bandwidth is equal to 350 MB/second based on the number of spare blocks. Because the writing data bandwidth is 50 MB/second, the bandwidth of the garbage-collection process will be 300 MB/second. The bandwidth of the garbage-collection process is greater than the writing data bandwidth, and the number of spare blocks will be increased again and close to the predetermined value.

At time T6, the controller 120 determines that the number of spare blocks in the flash memory 140 is 20, which is lower than the predetermined value, and it determines that the threshold bandwidth is equal to 150 MB/second based on the number of spare blocks. Because the writing data bandwidth is 500 MB/second, the bandwidth of the garbage-collection process will be OMB/second.

At time T7, the controller 120 determines that the number of spare blocks in the flash memory 140 is 13, which is lower than the predetermined value, and it determines that the threshold bandwidth is equal to 350 MB/second based on the number of spare blocks. Because the writing data bandwidth is OMB/second, the bandwidth of the garbage-collection process will be 350 MB/second. The bandwidth of the garbage-collection process is greater than the writing data bandwidth, and the number of spare blocks will be increased again and close to the predetermined value.

As illustrated above, when the writing data bandwidth increases, the bandwidth of the garbage-collection process will be decreased by the controller 120. When the writing data bandwidth decreases, the bandwidth of the garbage-collection process will be increased by the controller 120. Therefore, the relationship between the writing data bandwidth and the bandwidth of the garbage-collection process is similar to a seesaw, so that the garbage-collection process can function properly to avoid affecting system performance.

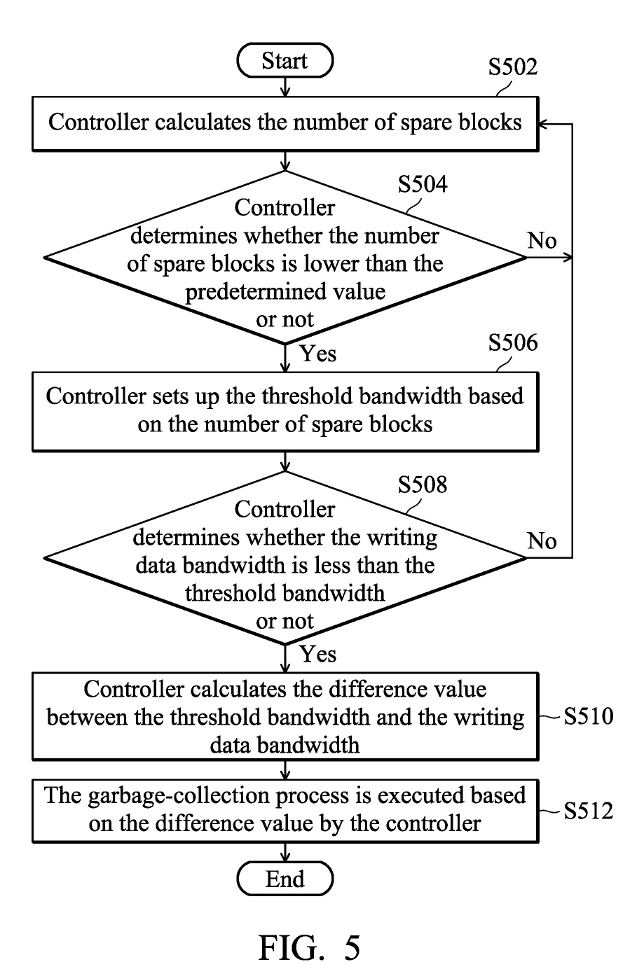

The difference value between the predetermined value and the number of spare blocks when the flash memory 140 executes the garbage-collection process is illustrated further below. FIG. 5 is a schematic illustrating a data storage method for executing the intellectual garbage-collection process according to an embodiment of the invention. In the embodiment, the predetermined value is 25. When the controller 120 calculates that the number of spare blocks is less than 25 which means that the number of spare blocks is not enough, the garbage-collection process should be executed to release more spare blocks. When the number of spare blocks is less or the difference value between that and the predetermined value is more, the threshold bandwidth set up by the controller 120 will become greater.

In step S502, the controller 120 (periodically) calculates the number of spare blocks. In step S504, the controller 120 determines whether or not the number of spare blocks is lower than the predetermined value. If it is lower than the predetermined value, step S502 will be executed again. At time T1, the controller 120 calculates that the number of spare blocks in the flash memory 140 is not lower than the predetermined value. In other words, the number of spare blocks is enough. If it is lower than the predetermined value, step S506 will be executed that the controller 120 sets up the threshold bandwidth based on the number of spare blocks. At time T2, the controller determines that the number of spare blocks in the flash memory 140 is 20 which is lower than the predetermined value.

In step S508, the controller 120 determines whether or not the writing data bandwidth is less than the threshold bandwidth. If it is not less than the threshold bandwidth, step S502 will be executed again. If it is less than the threshold bandwidth, step S510 will be executed that the controller 120 calculates the difference value between the threshold bandwidth and the writing data bandwidth. The controller 120 determines that the threshold bandwidth is equal to 150 MB/second based on the number of spare blocks. Meanwhile, the writing data bandwidth is 100 MB/second, and the difference value between the threshold bandwidth and the writing data bandwidth is 50 MB/second accordingly.

In step S512, the garbage-collection process is executed by the controller 120 based on the difference value. The garbage-collection process is executed by the controller 120 at a speed of 50 MB/second, and the intellectual garbage-collection process is complete.

The bandwidth and speed of the garbage-collection process are adjusted dynamically based on the comparison of the predetermined value and the number of spare blocks by the present invention. When the host 200 writes more data, the number of spare blocks decreases. Calculating the number of spare blocks could reflect the situation of wiring data by the host 200. However, the present invention does not initiate the garbage-collection process immediately when the host 200 writes data, and it does not allow the garbage-collection process to consume the access speed of the flash memory 140. The bandwidth and speed of the garbage-collection process will be adjusted dynamically after a period of time. Therefore, writing latency can be prevented and the number of spare blocks can be maintained by the data storage method of the present invention so that the data storage device 100 can operate properly and smoothly.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A data storage device for dynamically executing a garbage-collection process, comprising:
a flash memory, comprising a plurality of blocks, wherein each of the blocks comprises a plurality of pages; and
a controller, coupled to the flash memory, configured to calculate whether or not number of at least one spare block is lower than a predetermined value, and execute the garbage-collection process according to a difference value between the predetermined value and the number of spare blocks, wherein the garbage-collection process merges at least two data blocks to release at least one spare block.

2. The data storage device for dynamically executing a garbage-collection process claimed in claim 1, wherein:
when the number of spare blocks in the flash memory is lower than the predetermined value, the controller sets up a threshold bandwidth based on the number of spare blocks, wherein when the difference value between the predetermined value and the number of spare blocks is greater, or there are fewer spare blocks, the threshold bandwidth is greater.

3. The data storage device for dynamically executing a garbage-collection process claimed in claim 2, wherein:
the controller determines whether or not a writing data bandwidth is less than the threshold bandwidth, and the writing data bandwidth is a speed at which the host writes data into the data storage device.

4. The data storage device for dynamically executing a garbage-collection process as claimed in claim 3, wherein:
when the writing data bandwidth is less than the threshold bandwidth, the controller calculates the difference value between the threshold bandwidth and the writing data bandwidth and executes the garbage-collection process based on the difference value.

5. The data storage device for dynamically executing a garbage-collection process claimed in claim 4, wherein:
when the writing data bandwidth is greater than the threshold bandwidth, the controller does not initiate the garbage-collection process; and
when the writing data bandwidth is smaller than the threshold bandwidth, the controller initiates the garbage-collection process.

6. The data storage device for dynamically executing a garbage-collection process claimed in claim 4, wherein:
when the writing data bandwidth is smaller or the threshold bandwidth is greater, the bandwidth of the garbage-collection process executed by the controller is greater.

7. The data storage device for dynamically executing a garbage-collection process claimed in claim 1, wherein:
the controller periodically calculates the number of spare blocks in the flash memory, and it determines whether or not the number of spare blocks is lower than the predetermined value.

8. A data storage method for dynamically executing a garbage-collection process, wherein the flash memory comprises a plurality of blocks, and each of the blocks comprises a plurality of pages, the data storage method comprising:
calculating the number of spare blocks in the flash memory;
determining whether or not the number of spare blocks is lower than a predetermined value; and
executing the garbage-collection process according to the difference value between the predetermined value and the number of spare blocks, wherein the garbage-collection process merges at least two data blocks to release at least one spare block.

9. The data storage method for dynamically executing a garbage-collection process claimed in claim 8, wherein:
when the number of spare blocks in the flash memory is lower than the predetermined value, a threshold bandwidth based on the number of spare blocks is set up, wherein when the difference value between the predetermined value and the number of spare blocks is greater, or when there are fewer blocks, the threshold bandwidth is greater.

10. The data storage method for dynamically executing a garbage-collection process claimed in claim 9, further comprising:
determining whether or not the writing data bandwidth is less than the threshold bandwidth, wherein the writing data bandwidth is the speed at which the host writes data into the data storage device.

11. The data storage method for dynamically executing a garbage-collection process claimed in claim 10, wherein:
when the writing data bandwidth is less than the threshold bandwidth, the bandwidth is calculated, and the garbage-collection process is executed based on the difference value.

12. The data storage method for dynamically executing a garbage-collection process claimed in claim 11, wherein:
when the writing data bandwidth is greater than the threshold bandwidth, the garbage-collection process is not initiated; and
when the writing data bandwidth is smaller than the threshold bandwidth, the garbage-collection process is initiated.

13. The data storage method for dynamically executing a garbage-collection process claimed in claim 11, wherein:
when the writing data bandwidth is smaller or the threshold bandwidth is greater, the bandwidth of the garbage-collection process executed by the controller is greater.

14. The data storage method for dynamically executing a garbage-collection process claimed in claim 8, further comprising:
periodically calculating the number of spare blocks in the flash memory, and determining whether or not the number of spare blocks is lower than the predetermined value.
